(19) United States
(12) Patent Application Publication
(10) Pub. No.: US 2018/0054078 A1
(43) Pub. Date: Feb. 22, 2018

(54) DEVICE HAVING WIRELESS CHARGING FUNCTION AND WIRELESS CHARGING SYSTEM

(71) Applicant: ZMODO TECHNOLOGY SHENZHEN CORP. LTD, Shenzhen (CN)

(72) Inventor: Kevin Kelin Wan, Shenzhen (CN)

(21) Appl. No.: 15/454,447

(22) Filed: Mar. 9, 2017

(30) Foreign Application Priority Data
Aug. 19, 2016 (CN) 201620912917.3

(51) Int. Cl. H02J 7/02; H02J 7/00

(52) U.S. Cl. CPC H02J 7/025; H02J 7/0042

(57) ABSTRACT

A device having a wireless charging function comprises: a housing having a carrying surface configured to carry the external apparatus; a circuit board disposed in the housing to control charging of the device; a wireless coil disposed in the housing and connected to the circuit board, wherein the wireless coil is configured to receive a magnetic energy signal or transmit a magnetic energy signal under control of the circuit board; and a magnetic isolation element disposed in the housing and provided with a recess, wherein the magnetic isolation element is fixed on the carrying surface; the recess faces to the carrying surface; and the wireless coil is fixed in the recess.

### RELATED APPLICATIONS

This application claims priority under 35 U.S.C. §119 to Chinese Patent Application No, 20162091.2917.3, filed on Aug. 19, 2016, the entire content of which is incorporated herein in its entirety.

### FIELD OF THE INVENTION

The present disclosure relates to a wireless charging technical field, and particularly relates to a device having a wireless charging function and a wireless charging system.

### BACKGROUND OF THE INVENTION

As development of the wireless charging technique, more and more power consuming devices and power supply devices are integrated with wireless charging modules to implement the wireless charging function. The charging efficiency of the conventional wireless charging process is lower, resulting in a severe heat generation, which affects performance of the product.

### SUMMARY OF THE INVENTION

Accordingly, it is necessary to provide a device having a wireless charging function and a higher charging efficiency, and further provide a wireless charging system.

A device having a wireless charging function includes a housing having a carrying surface configured to carry the external apparatus, a circuit board disposed in the housing to control charging of the device, a wireless coil disposed in the housing and connected to the circuit board and configured to receive a magnetic energy signal or transmit a magnetic energy signal under control of the circuit board, and a magnetic isolation element disposed in the housing. The magnetic isolation element is provided with a recess. The magnetic isolation element is fixed on the carrying surface and the recess faces to the carrying surface. The wireless coil is fixed in the recess.

A wireless charging system includes a receiving terminal. The receiving terminal has a carrying surface configured to carry a transmitting terminal. The receiving terminal further includes a circuit board configured to control charging of the receiving terminal and a receiving coil connected to the circuit board. The receiving coil is configured to receive a magnetic energy signal under control of the circuit board and a receiving magnetic isolation element provided with a recess. The receiving magnetic isolation element is fixed on the carrying surface, and the recess faces to the carrying surface. The receiving coil is fixed in the recess.

The above device having a wireless charging function can isolate the wireless coil from the external by disposing the wireless coil in the recess of the magnetic isolation element, which effectively isolates the inside magnetic field from the external magnetic field, reduces the magnetic flux leakage rate and improves the charging efficiency.

The above and other features of the disclosure including various novel details of construction and combinations of parts, and other advantages, will now be more particularly described with reference to the accompanying drawings and pointed out in the claims. It will be understood that the particular method and device embodying the disclosure are shown by way of illustration and not as a limitation of the disclosure. The principles and features of this disclosure may be employed in various and numerous embodiments without departing from the scope of the disclosure.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 shows a schematic diagram of a device having a wireless charging function in an embodiment;

FIG. 2 shows a schematic diagram of a transmitting magnetic isolation element of FIG. 1;

FIG. 3 shows a schematic working diagram of a transmitting magnetic isolation element of FIG. 1;

FIG. 4 shows a schematic diagram of a device having a wireless charging function in another embodiment;

FIG. 5 shows a schematic diagram of a wireless charging system in an embodiment;

FIG. 6 shows a schematic diagram of an application of the wireless charging system of FIG. 5 in a door sensor, in which a fixing device is located by using magnetism;

FIG. 7 shows a schematic diagram of an application of the wireless charging system of FIG. 5 in a door sensor, in which a fixing device is fixed by using bionics;

FIG. 8 shows a schematic diagram of an application of the wireless charging system of FIG. 5 in a door sensor, in which a fixing device is fixed by using a magic band;

FIG. 9 shows a schematic diagram of an application of the wireless charging system of FIG. 5 in a wireless smoke detector, in which a fixing device is located by using magnetism;

FIG. 10 shows a schematic diagram of an application of the wireless charging system of FIG. 5 in a camera, in which a fixing device is located by using a sucker.

### DETAILED DESCRIPTION OF THE EMBODIMENTS

Embodiments of the disclosure are described more fully hereinafter with reference to the accompanying drawings, in which preferred embodiments of the disclosure are shown. The various embodiments of the disclosure may, however, be embodied in many different forms and should not be construed as limited to the embodiments set forth herein, Rather, these embodiments are provided so that this disclosure will be thorough and complete, and will fully convey the scope of the disclosure to those skilled in the art.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. Herein terms used in the specification of the disclosure aim at describing the specific embodiments without limiting the disclosure. Terms “ and/or ” used herein comprise any and all combination of one or more related item listed.

A device having a wireless charging function is provided in an embodiment. The device can power an external apparatus wirelessly or be powered wirelessly by the external apparatus. That is to say, the device can not only be a power consuming device, but also be a power supply device such as a charger. FIG. 1 shows a schematic structure diagram of a device 100 having a wireless charging function in an embodiment. The device 100 is a power supply device, that is to say, it can transmit a magnetic energy signal to power an external apparatus wirelessly. The device includes a housing 110, a circuit board 120, a transmitting coil 130 and a transmitting magnetic isolation element 140.

The housing 110 is configured to receive and protect the elements in the device 100. The circuit board 120, the transmitting coil 130 and the transmitting magnetic isolation element 140 are disposed in the housing 110. The housing 110 is disposed with a carrying surface 112 configured to carry the external apparatus to be charged. In an embodiment, a positioning mark can also be disposed on the carrying surface 112. The positioning mark is configured to cooperate with a positioning mark of the external apparatus to implement match of the wireless coils (a receiving coil 130 and a transmitting coil). The positioning mark can be a projection formed on the carrying surface, or a pattern mark formed on a carrying surface. In general, the positioning mark on the carrying surface 112 needs to be disposed to match with the positioning nark on the external apparatus.

The circuit board 120 is connected to the transmitting coil 130 to control discharging of the device 100. Particularly, the circuit board 120 is configured to convert electrical energy into a transmittable alternating current by electrical processing and transmit a magnetic energy signal by a transmitting coil 130. The electrical energy converted by the device 100 can be input by the external power supply or can be provided by energy storage of the device 100. In the embodiment, the device 100 further includes a power supply input port 150 and an energy storage device 160. The power supply input port 150 is fixed on the housing 110. The power supply input port 150 is connected to the circuit board 120 and configured to be connected to the mains such as the external power supply. The power supply input port 150 transmits power of the mains to the circuit board 120 and the circuit board 120 processes the power and transmits the processed power to the transmitting coil 130 or the energy storage device 160. The energy storage device 160 is connected to the circuit board 120 to store the electrical energy or provide the electrical energy to the external. That is to say, when the power supply input port 150 is not connected to the external power supply, the device 100 can transmit a magnetic energy signal to the external by using the energy stored in the energy storage device 160. The energy storage device 160 can be a charging device such as an alkaline battery, a storage battery or the like. The capacity of the energy storage device 160 can be disposed according to requirement. The circuit board 120 includes a transmitting terminal chip board 122 and a power supply management chip 124, wherein the transmitting terminal chip board 122 includes processing modules such as an inverter module, a rectifier module and the like, so that the transmitting coil 130 can be controlled. The power supply management chip 124 is configured to control the external power supply to charge the chargeable medium actively or passively. In an embodiment, the transmitting terminal chip board 122 and the power supply management chip 124 can be disposed separately. In other embodiments, the transmitting terminal chip board 122 and the power supply management chip 124 can be integrated on one circuit board.

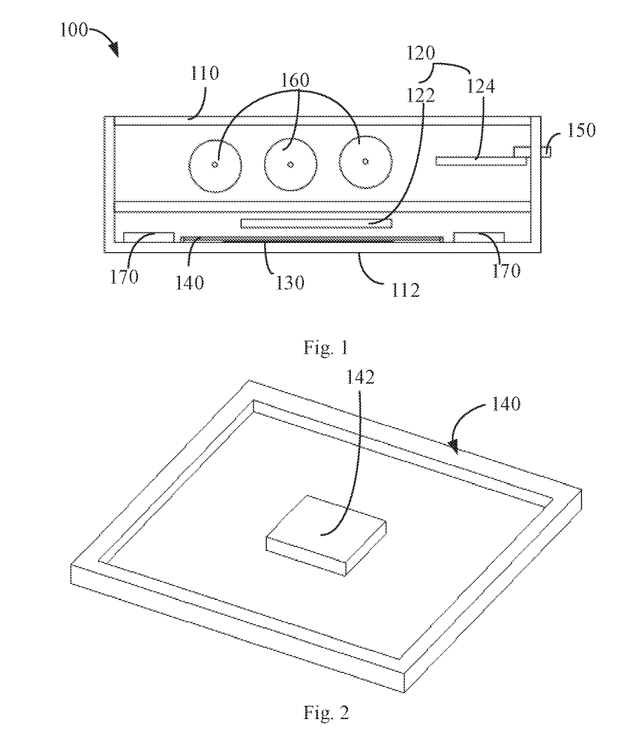

The transmitting magnetic isolation element 140 is configured to isolate the transmitting coil from electromagnetic radiation to reduce the magnetic flux leakage rate. FIG. 2 shows a schematic structure diagram of a transmitting magnetic isolation element 140. A recess is formed at a side of the transmitting magnetic isolation element 140. The transmitting magnetic isolation element 140 is fixed on the carrying surface 112 and the recess faces to the carrying surface 112. The transmitting coil 130 is fixed in the recess, so that the transmitting coil 130 is isolated by the transmitting magnetic isolation element 140, which can effectively isolate the wireless coil from the external and then ensure the effective isolation of the external magnetic field and the inside magnetic field to reduce the magnetic flux leakage rate and improve the charging efficiency. At the same time, compared to the conventional device having a wireless charging function, the edge area of the transmitting magnetic isolation element 140 is closer to the apparatus to be charged relative to the central area, so that the distance between the transmitting magnetic isolation element 140 and the receiving magnetic isolation element in the apparatus to be charged is reduced, that is to say, the air gap is reduced and then the magnetic flux leakage rate is further reduced, which enhances the isolation effect and improves the charging efficiency. The depth of the recess of the transmitting magnetic isolation element 140 should be larger than or equal to the thickness of the transmitting coil 130. In the embodiment, a projection 142 can also be disposed in the recess of the transmitting magnetic isolation element 140. The height of the projection 142 should be lower than or equal to the depth of the recess. The shape of the projection 142 can be a rectangle, a circle, an ellipse and another irregular pattern. The transmitting coil 130 is sleeved around the projection 142, that is to say, the transmitting coil 130 is located between the edge of the transmitting magnetic isolation element 140 and the projection 142. By disposing the projection in the middle of the transmitting magnetic isolation element 140, the magnetic induction density in the middle can be reduced and the magnetic saturation limit can be improved. The magnetic saturation can result in an over-large eddy of the magnetic isolation plate, damage the device due to the severe heat generation and limit the charging efficiency. This problem can be well resolved by disposing the projection 142 on the transmitting magnetic isolation element 140. Meanwhile, by disposing the projection 142 in the middle of the transmitting magnetic isolation element 140, the flow direction of the magnetic induction lines can be induced and accuracy of middle transmission of the magnetic induction lines can be ensured. The projection 142 can be made of ferrite material. In the embodiment, the transmitting magnetic isolation element 140 can be made of soft magnetic material.

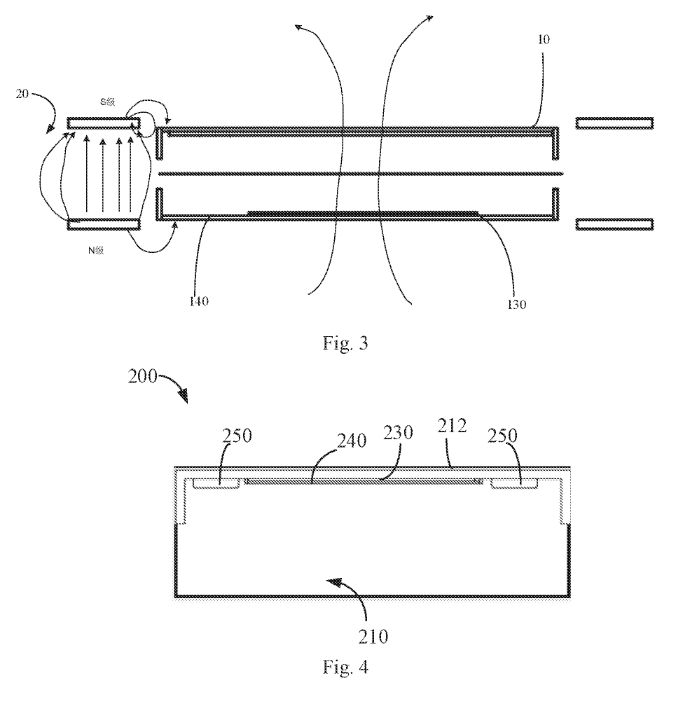

FIG. 3 shows a schematic working diagram of the transmitting magnetic isolation element 140, wherein the reference number “10” indicates the magnetic isolation element in the apparatus to be charged, and the reference number “20” indicates the external magnetic field. It can be seen from FIG. 3 that both the transmitting magnetic isolation element 140 and the magnetic isolation element 10 can well implement isolation between the outside magnetic field and the inside magnetic field, and reduce the magnetic flux leakage rate, so that the charging efficiency can be improved.

The above device 100 enables the transmitting coil 130 to isolate from the external effectively by disposing the transmitting coil 130 in the recess of the transmitting magnetic isolation element 140, which can ensure effective isolation of the external magnetic field and the inside magnetic field, reduce the magnetic flux leakage rate and improve the charging efficiency.

In the embodiment, the above device 100 further includes a fixing device 170. The fixing device 170 is configured to fix the device 100 with the external apparatus. The fixing device 170 can be a magnetic adsorbing device, a pressure adsorbing device, an adhesive device or the like. In the embodiment, the fixing device 170 can be a magnetic adsorbing device. The fixing device 170 is fixed on the carrying surface 112 and located outside of the transmitting magnetic isolation element 140. Therefore, the transmitting magnetic isolation element 140 can isolate the transmitting coil 130 from the fixing device 170, which prevents from magnetic leakage when the magnetoelectric conversion is performed, reduces influence of the outside magnetic field for the inside magnetic field, and improves the charging efficiency.

The fixing device 170 can be a magnet or other magnetic materials. At this time, the external apparatus needs to be disposed with a fixing device which has a magnetic attraction with the fixing device 170, so that they can attract with each other and be located firmly. For example, the permanent magnets or the electromagnets are disposed in the device 100 and the external apparatus as the fixing device 170, or a permanent magnet is disposed in one of the device 100 and the external apparatus, and the other one is disposed as a magnetic material. In other embodiments, the fixing device 170 can be a sucker structure fixed outside of the carrying surface. A powerful adsorption force can be generated by denseness of the sucker structure, so as to fix the device 100 with the external apparatus. The sucker can perform the sucking fixation by using soft materials, which satisfies different fixation requirements of different devices such as the roof, the wall and the like. The fixing device 170 can be adhesively fixed to any surface by using the nanotechnology, such as a similar fixation manner to the gecko band, this fixation manner perform the adsorption function mainly by applying the Van der Waals forces among the molecules. The fixing device can be a structure such as a nylon buckle or the like, at this time a matched buckle has to be disposed on the external apparatus. The fixing device 170 can be also a concave deformation band, which applies a clamping force to the back by deformation of the reverse side due to force. This fixation manner is suitable for a tubular apparatus such as a tubular sensor. There can be a plurality of fixing devices 170 which are distributed on the carrying surface symmetrically to implement firm fixation between the device 100 and the external apparatus. In other embodiments, the fixing device 170 cannot be disposed. The device 100 and the external apparatus can be fixed together by gravity, that is to say, the device 100 is placed on the carrying surface of the external apparatus.

FIG. 4 shows a schematic structure diagram of a device 200 having a wireless charging function in another embodiment. The device 200 is a power consuming device; that is to say, the device 200 can receive a magnetic energy signal transmitted by the external apparatus to be wirelessly charged by the external apparatus. The device 200 includes a power consuming body 210, a circuit board (not shown), a receiving coil 230 and a receiving magnetic isolation element 240.

The power consuming body 210 is the main body of the device 200 to implement the core function of the device 200. The power consuming body 210 can be an intelligent home apparatus such as a door sensor, a smoke sensor, a human body detector, an environmental sensor, an intelligent monitoring apparatus, an alarm system and the like, or can be another digital product. The power consuming body 210 is also disposed with a carrying surface 212. The carrying surface 212 is configured to carry the power supply device such as the wireless charger (such as the device 100) and the like. The carrying surface 212 is also disposed with a positioning mark cooperated with the device 100, so that alignment between the transmitting coil 130 and the receiving coil 230 can be implemented.

The circuit board is connected to the receiving coil 230 to control charging of the device 200. In particular, the receiving coil 230 is configured to receive a magnetic energy signal transmitted by the device 100 and convert the magnetic energy signal into alternating current. The circuit board is configured to process the alternating current to power the power consuming body 210, which satisfies the power consuming requirement of the power consuming body 210.

The receiving magnetic isolation element 240 is configured to isolate the receiving coil 230 from electromagnetism to reduce the magnetic flux leakage rate. The structure of the receiving magnetic isolation element 240 is the same as the transmitting magnetic isolation element 140 that has already been described. The structure of the receiving magnetic isolation element 240 is disposed opposite to the transmitting magnetic isolation element 140, so as to ensure accurate alignment between the transmitting coil 130 and the receiving coil 230.

In the embodiment, the device 200 is also disposed with a fixing device 250 cooperated with the fixing device 170. The fixing device 250 can be made of a magnetic material, a bionic sucker, a nylon adhesive band or the like.

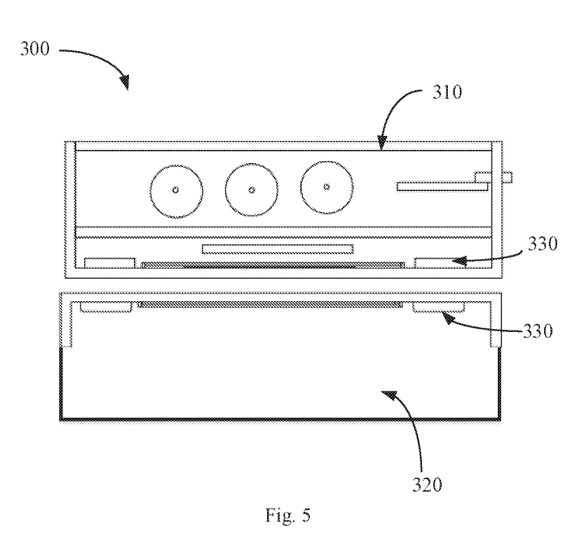

FIG. 5 shows a schematic structure diagram of a wireless charging system 300 in an embodiment. The wireless charging system 300 includes a transmitting terminal 310, a receiving terminal 320 and the fixing device 330. The structure of the transmitting terminal 310 is the same as the structure of the device 100 in the above embodiment. The structure of the receiving terminal 320 is the same as the structure of the device 200 in the above embodiment. The fixing device 330 is configured to fix the transmitting terminal 310 on the carrying surface of the receiving terminal 320. The fixing device 330 can be fixed by the fixation manners mentioned above. In the embodiment, the fixing device 330 can be fixed by using magnetic location. In other embodiments, the fixing device 330 cannot be disposed in the wireless charging system 300. The transmitting terminal 310 can convert the external power supply such as the mains or the energy stored inside into a magnetic energy signal and transmit the magnetic energy signal to the receiving terminal 320. The receiving terminal 320 receives the magnetic energy signal and converts the magnetic energy signal into an electrical energy to power the power consuming device, which satisfies the power consuming requirement of the power consuming device, The transmitting terminal 310 can be replaced in time in the event of failure by separately disposing the transmitting terminal 310 outside of the receiving terminal 320, which reduces the maintenance cost and improves the maintenance efficiency.

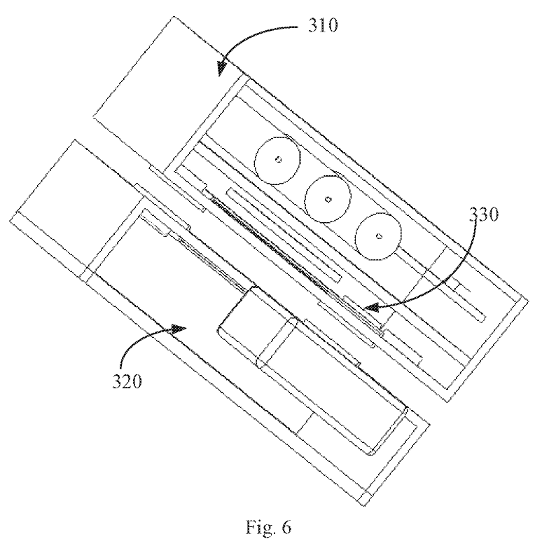

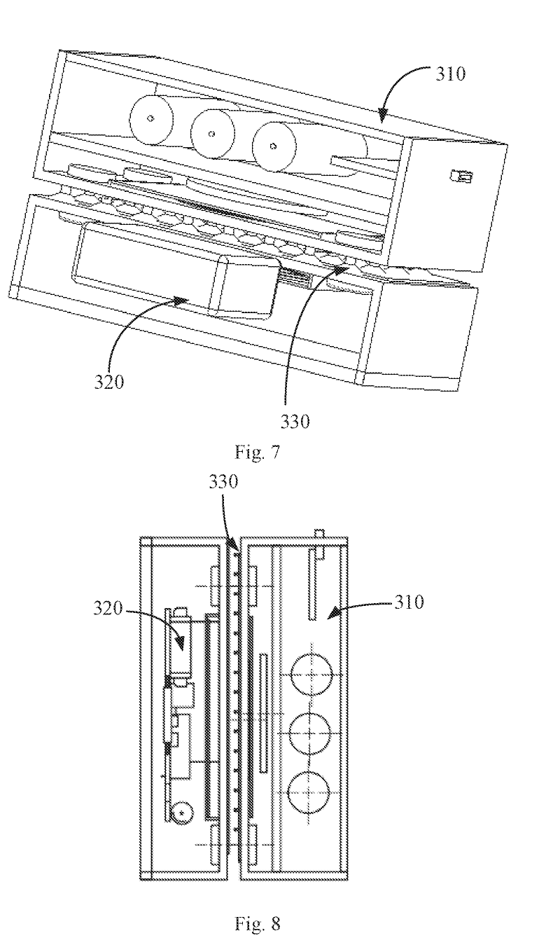

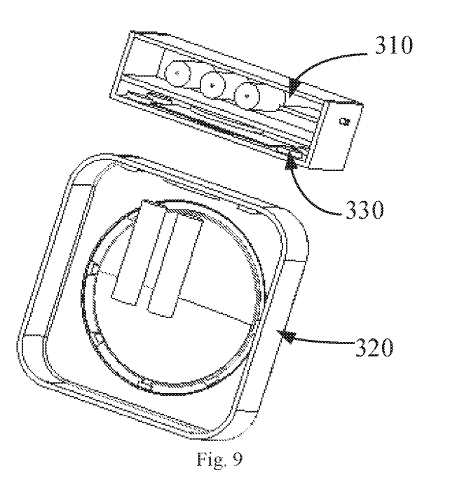

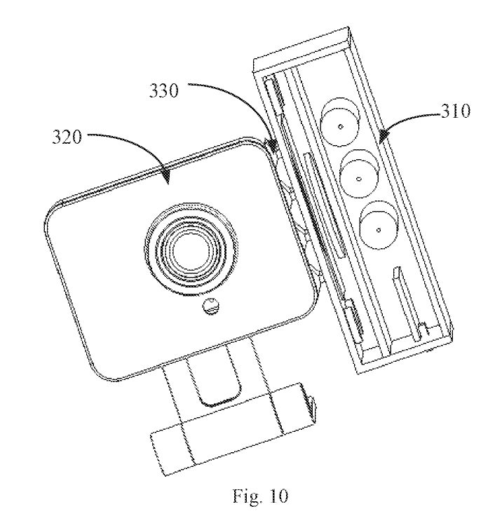

FIG. 6 shows a schematic diagram of an application of the wireless charging system 300 in a wireless door sensor, wherein the :fixing device 330 is fixed by using magnetism. FIG. 7 shows a schematic diagram of an application of the wireless charging system 300 in a wireless door sensor, wherein the fixing device 330 is fixed by using bionics (i.e. fixation by a sucker). FIG. 8 shows a schematic diagram of an application of the wireless charging system 300 in a wireless door sensor, wherein the fixing device 330 is fixed by using a magic band (i.e. a nylon buckle and the like). In FIGS. 6 to 8, the reference number “320” indicates the wireless door sensor structure. FIG. 9 shows a schematic diagram of an application of the wireless charging system 300 in a wireless smoke detector, wherein the fixing device 330 is fixed by using magnetism, and the reference number “320” indicates the schematic structure diagram of the wireless smoke detector. FIG. 10 shows a schematic diagram of application of the wireless charging system 300 in an intelligent monitoring device such as a camera, wherein the fixing device 330 is located by using a sucker, and the reference number “320” indicates the schematic structure diagram of the camera. The sucker is a bionics sucker with a high density to provide a powerful adsorption force, which ensures good cooperation between the receiving terminal 320 and the transmitting terminal 310. It can be understood that the wireless charging system 300 in the embodiment can be also applied to other intelligent home products and digital products.

Although the disclosure is illustrated and described herein with reference to specific embodiments, the disclosure is not intended to be limited to the details shown. Rather, various modifications may be made in the details within the scope and range of equivalents of the claims and without departing from the disclosure.

What is claimed is:

1. A device having a wireless charging function, comprising:
a housing having a carrying surface configured to carry an external apparatus;
a circuit board disposed in the housing and configured to control charging of the device;
a wireless coil disposed in the housing and connected to the circuit board, wherein the wireless coil is configured to receive a magnetic energy signal or transmit a magnetic energy signal under control of the circuit board; and
a magnetic isolation element disposed in the housing, wherein the magnetic isolation element is provided with a recess; the magnetic isolation element is fixed on the carrying surface and the recess faces to the carrying surface; and the wireless coil is fixed in the recess.

2. The device of claim I, wherein a projection is formed in the recess, a height of the projection is less than or equal to a depth of the recess, and the wireless coil is sleeved on the projection.

3. The device of claim 1, further comprising a fixing device configured to fix the device with the external apparatus.

4. The device of claim 3, wherein the fixing device is at least one of a magnetic adsorbing device, a pressure adsorbing device, and an adhesive device.

5. The device of claim 1, wherein the outside surface of the carrying surface of the housing is disposed with a positioning mark, and the positioning mark is configured to match with a positioning mark of the external apparatus to implement alignment of the wireless coil and a wireless coil in the external apparatus.

6. The device of claim 1, further comprising an energy storage device, wherein the energy storage device is disposed in the housing and electrically connected to the circuit board.

7. The device of claim 1, further comprising a power supply input port, wherein the power supply input port is fixed on the housing and connected to the circuit board.

8. A wireless charging system, comprising a receiving terminal, the receiving terminal comprising:
a carrying surface configured to carry a transmitting terminal;
a circuit board configured to control charging of the receiving terminal;
a receiving coil connected to the circuit board, wherein the receiving coil is configured to receive a magnetic energy signal under control of the circuit board; and
a receiving magnetic isolation element provided with a recess, wherein the receiving magnetic isolation element is fixed on the carrying surface; the recess faces to the carrying surface; and the receiving coil is fixed in the recess.

9. The wireless charging system of claim 8, further comprising a transmitting terminal configured to convert electrical energy into magnetic energy and output the magnetic energy to the receiving terminal, wherein the transmitting terminal is disposed on the carrying surface of the receiving terminal, the receiving terminal comprising:
a housing having a carrying surface configured to carry the receiving terminal;
a power supply input port fixed on the housing and connected to an external power supply;
a circuit board disposed in the housing and connected to the power supply input terminal, wherein the circuit board is configured to control discharging of the transmitting terminal;
a transmitting coil disposed in the housing and connected to the circuit board, wherein the transmitting coil is configured to transmit a magnetic energy signal under control of the circuit board; and
a transmitting magnetic isolation element disposed in the housing, wherein the transmitting magnetic isolation element is provided with a recess, the transmitting magnetic isolation element is fixed in the recess, the transmitting magnetic isolation element is fixed on the carrying surface of the housing, the recess faces to the carrying surface, and the transmitting magnetic isolation element is disposed opposite to the receiving magnetic isolation element, so that the transmitting coil is aligned with the receiving coil.

10. The wireless charging system of claim 9, further comprising a fixing device configured to fix the transmitting terminal on the carrying surface of the receiving terminal.

11. The wireless charging system of claim 10, wherein the fixing device is at least one of a magnetic adsorbing device, a pressure adsorbing device and an adhesive device.
